(19) United States
(12) Patent Application Publication
(10) Pub. No.: US 2009/0114787 A1
(43) Pub. Date: May 7, 2009

(54) VERSATILE BRACKET SYSTEM FOR DISPLAY DEVICES

(75) Inventor: Ellen Glassman, Closter, NJ (US)

Correspondence Address: GREENBERG TRAURIG, LLP, 77 WEST WACKER DRIVE, SUITE 3100, CHICAGO, IL, 60601-1732, US

(73) Assignee: Sears Brands, L.L.C., Hoffman Estates, IL (US)

(21) Appl. No.: 11/936,398

(22) Filed: Nov. 7, 2007

(51) Int. Cl. F16C 11/06

(52) U.S. Cl. 248/288.31

(57) ABSTRACT

A versatile bracket system for display devices includes a component that is attached to a backside of the display device. The component is moveable about the attachment between a first position relative to the backside of the display device and a second position relative to the backside of the display device. The first position of the component allows the component to be attached to an underside surface to thereby place the display device in a hanging viewing position. The second position of the component allows the component to cooperate with the display device and a topside surface to thereby place the display device in a standing viewing position.

### BACKGROUND

In the art, brackets for display devices, such as televisions, computer monitors, etc., are known in the art. By way of example, U.S. Pat. No. D 541,138 illustrates a bracket for use in mounting a display device to a piece of furniture. By way of further example, U.S. Pat. No. 5,007,608 illustrates and describes a bracket for attaching a display device to a wall.

### SUMMARY

The following describes a versatile bracket system for use in connection with a display device, such as television, computer monitor, and the like. The versatile bracket system includes a component, such as a rod, a plate, or equivalent, that is attached to a backside of the display device, for example using a hinge, a ball joint, or equivalent. In this manner, the component is moveable about the attachment between a first position relative to the backside of the display device and a second position relative to the backside of the display device. The first position of the component allows the component to be attached to an underside surface, or a wall, to thereby position the display device in a hanging viewing position. The second position of the component cooperates with the display device and a topside surface to thereby position the display device in a standing viewing position.

A better understanding of the objects, advantages, features, properties and relationships of the subject system will be obtained from the following detailed description and accompanying drawings which set forth illustrative embodiments and which are indicative of the various ways in which the principles of the system may be employed.

### BRIEF DESCRIPTION OF THE DRAWINGS

For a better understanding of the versatile bracket reference may be had to the following drawings in which:

FIG. 1 is a front perspective view showing an exemplary component in the form of a plate being used to support a display device on a surface such as a table top;

FIG. 2 is a front perspective view showing the exemplary component of FIG. 1 being used to mount a display device to a surface such as a cabinet underside or soffit underside;

FIG. 3 is a rear perspective view showing the exemplary component of FIG. 1 again being used to support a display device on the surface such as a table top;

FIG. 4 is a rear perspective view of the exemplary component shown in each of FIGS. 1-3;

FIG. 5 is a front perspective view showing a further exemplary component in the form of a rod being used to support a display device on a surface such as a table top;

FIG. 6 is a front perspective view showing the exemplary component of FIG. 5 being used to mount a display device to a surface such as a cabinet underside, soffit underside, or a wall;

FIG. 7 is a rear perspective view showing the exemplary component of FIG. 5 again being used to support a display device on the surface such as a table top;

FIG. 8 is a front perspective view of the exemplary component shown in each of FIGS. 5-7.

### DETAILED DESCRIPTION

With reference to the figures, embodiments of a versatile bracket system for use in connection with a display device, such as a television, computer monitor, or like type of device capable of displaying images and/or video, is hereinafter described. As illustrated, the versatile bracket systems provide a means for both standing a display device upon a topside surface and for hanging the display device from an underside or vertical surface, such as the underside of a cabinet, underside of a soffit, or a wall.

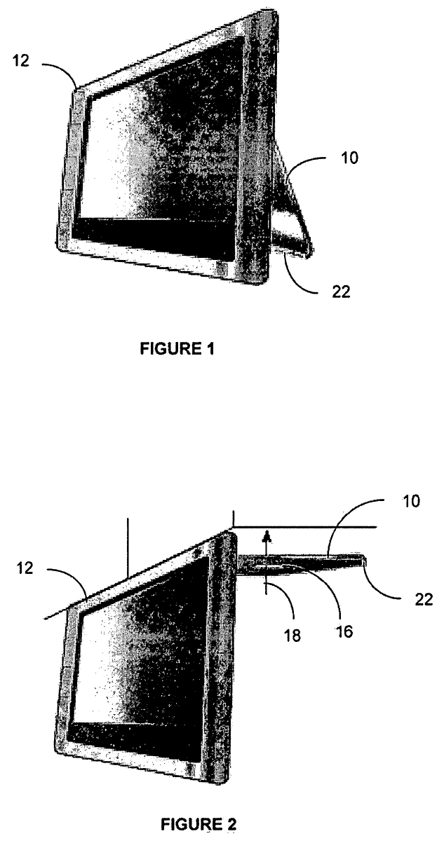

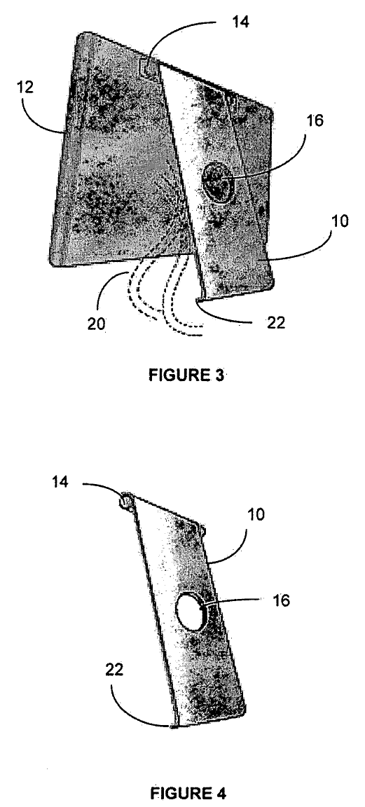

Turning first to FIGS. 1-4, a first exemplary embodiment of the versatile bracket system is illustrated and now described. In particular, the bracket system of FIGS. 1-4 includes a component, in the form of a plate 10, that is attached to a backside of a display device 12. The plate 10 may be attached to the backside of the display device 12 using a hinge 14 or like type of hardware. In this manner, the plate 10 is moveable between a first position, particularly shown in FIG. 2, and a second position, particularly shown in FIGS. 1 and 3. In the first position, the plate 10 extends generally horizontally from the backside of the display device 12, i.e., the plate 10 will form an angle of approximately ninety degrees relative to the backside of display device 12, whereupon the plate 10 may be attached to an underside surface, such as the bottom side of a cabinet, soffit, or the like, to thereby place the display device 12 into a hanging viewing position. In the second position, the plate 10 extends downwardly from the backside of the display device 12 at an angle of less than ninety degrees whereupon the plate 10 and bottom of the display device 12 cooperate to place the display device 12 into a standing viewing position upon a topside surface. In the first position, the top of the display device is preferably no higher than the surface of the plate 10 that is to be positioned against the underside surface to thereby allow the display device to be mounted entirely under the underside surface if so desired. In the second position, the plate 10 is used to prop up the display device 12 much like an easel back leg.

For mounting the plate 10 to the underside surface, the plate 10 may include one or more holes 16 though which conventional mounting hardware may be passed as shown by line 18. It will also be appreciated that, in either the first or second positions of the plate 10, the hole 16 may be used to pass through wiring 20 associated with the display device, such as a power cable, video cable(s), speaker cable(s), etc. To assist in maintaining the display device 12 in the standing viewing position upon a topside surface, the plate 10 may also be provided with a toe portion 22 that extends outwardly from the end of the plate 10 whereupon toe portion 22 will engage with the topside surface when the plate 10 is appropriately positioned. In some circumstances, the toe portion 22 can be sized and provided with mounting hardware accepting openings whereupon the toe portion 22 can be attached to a wall surface, with the plate 10 being placed in the first position, to thereby attach the display device 12 to a wall in a hanging viewing position. In still further circumstances, the plate 10 can be further pivotally attached to the backside of the display device 12 using conventional hardware to thereby allow the display device 12 to be rotated left and right relative to the plate 10.

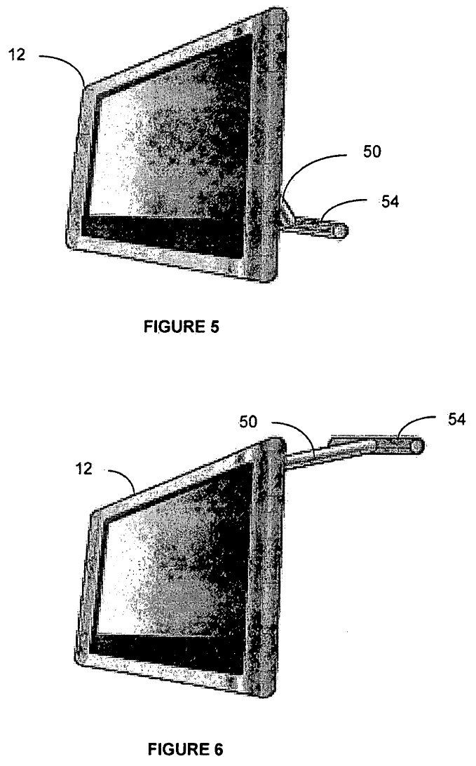

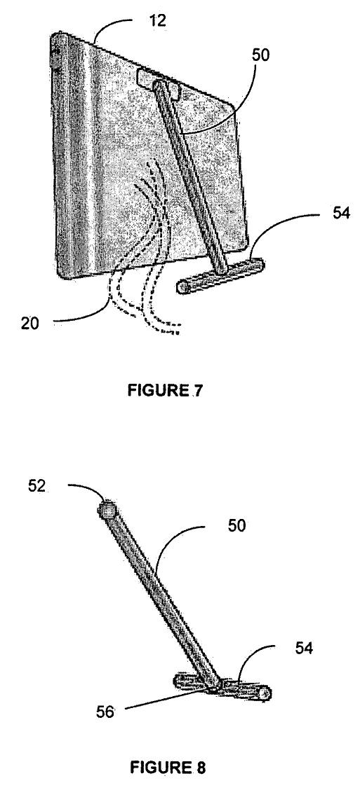

Turning now to FIGS. 5-8, a second exemplary embodiment of the versatile bracket system is illustrated and now described. In particular, the bracket system of FIGS. 5-8 includes a component, in the form of a rod 50, that is attached to a backside of a display device 12. The rod 50 may be attached to the backside of the display device 12 using a hinge to provide up and down movement of the rod 50 relative to the display device 12 or may be attached to the backside of the display device 12 using a ball joint 52 and cooperating ball joint socket to provide up and down movement of the rod 50 relative to the display device 12 as well as left and right movement of the display device 12 relative to the rod 50. In this manner, the rod 50 is at least moveable between a first position, particularly shown in FIG. 6, and a second position, particularly shown in FIGS. 5 and 7. In the first position, the rod 50 extends generally horizontally from the backside of the display device 12, i.e., the rod 50 will form an angle of approximately ninety degrees relative to the backside of display device 12, whereupon the plate 10 may be attached to an underside surface, such as the bottom side of a cabinet, soffit, or the like or to a wall, to thereby place the display device 12 into a hanging viewing position. In the second position, the rod 50 extends downwardly from the backside of the display device 12 at an angle of less than ninety degrees whereupon the rod 50 and bottom the display device 12 cooperate to place the display device 12 into a standing viewing position upon a topside surface. In the first position, the top of the display device is preferably no higher than the surface of the rod 50 that is to be positioned against the underside surface to thereby allow the display device 12 to be mounted entirely under the underside surface if so desired. In the second position, the rod 50 is used to prop up the display device 12 much like an easel back leg.

For mounting the rod 50 to the underside surface, conventional attachment hardware, for example U-shaped brackets, may be used to engage the rod 50 and mount the rod 50 to the underside surface. Still further, the rod 50 may include a pair of feet portions 54 that extend from opposite sides of an end of the rod 50 which pair of feet portions may be attached to an underside surface or a wall surface using conventional attachment hardware, such as a U-shaped bracket. It will also be appreciated that the feet portions 54 may additionally assist in maintaining the display device 12 in the standing viewing position upon a topside surface. In some circumstances, the rod 50 may be connected to the feet portions 54 using a ball joint and corresponding ball joint socket 56, together with or in lieu of the ball joint 52, to again provide up and down/left and right movement of the display device relative to the feet portions 54.

It will also be appreciated that the component that attaches to the back of the display device 12 may be adjustable in length. By way of example only, the rod 50 may be provided with telescoping parts and a locking mechanism whereby the rod 50 may be set to a desired length. In this manner, the rod 50 may be adjusted in length so that the rod 50 could be made longer for tabletop use while being made shorter for under-cabinet mounting.

While specific embodiments of the versatile bracket have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any equivalents thereof.

What is claimed is:

1. A system, comprising:
a display device; and
a component attached to a backside of the display device, the component being moveable about the attachment between a first position relative to the backside of the display device and a second position relative to the backside of the display device wherein the first position is used to attach the component to one of an underside surface or a wall surface to thereby position the display device in a hanging viewing position and the second position cooperates with the display device and a topside surface to thereby position the display device in a standing viewing position.

2. The system as recited in claim 1, wherein the first position comprises the component being disposed at an angle of approximately ninety degrees relative to the backside of the display device.

3. The system as recited in claim 2, wherein the second position comprises the component being disposed at an angle of less than ninety degrees relative to the backside of the display device.

4. The system as recited in claim 3, wherein the component is further pivotally attached to the backside of the display device such the display device can be rotated left and right relative to the component.

5. The system as recited in claim 4, comprising a ball joint used to attach the component to the backside of the display device.

6. The system as recited in claim 3, comprising a hinge used to attach the component to the backside of the display device.

7. The system as recited in claim 3, wherein the display device comprises a television.

8. The system as recited in claim 3, wherein the display device comprises a monitor screen.

9. The system as recited in claim 3, wherein the component comprises a plate having a hole for receiving hardware used to attach the component, disposed in the first position, to the underside surface.

10. The system as recited in claim 9, wherein the plate comprises a toe portion extending from a bottom of the plate towards the backside of the display device used to support the component, disposed in the second position, upon the topside surface.

11. The system as recited in claim 10, wherein the display device comprises a television.

12. The system as recited in claim 10, wherein the display device comprises a monitor screen.

13. The system as recited in claim 5, wherein the component comprises a rod around which hardware is used to attach the component, disposed in the first position, to the underside surface.

14. The system as recited in claim 13, wherein the display device comprises a television.

15. The system as recited in claim 13, wherein the display device comprises a monitor screen.

16. The system as recited in claim 5, wherein the component comprises a rod having at an end removed from the backside of the display device a pair of feet portions that extend from opposite sides of the rod around which hardware is used to attach the component, disposed in the first position, to the underside surface.

17. The system as recited in claim 16, wherein the display device comprises a television.

18. The system as recited in claim 16, wherein the display device comprises a monitor screen.

19. The system as recited in claim 16, comprising a ball joint used to attach the rod to the feet portions.

20. The system as recited in claim 19, wherein the display device comprises a television.

21. The system as recited in claim 19, wherein the display device comprises a monitor screen.

22. The system as recited in claim 1, wherein the component is adjustable in length.
